(19) United States
(12) Patent Application Publication
(10) Pub. No.: US 2011/0125302 A1
(43) Pub. Date: May 26, 2011

(54) METHOD AND SYSTEM FOR FORMAL SAFETY VERIFICATION OF MANUFACTURING AUTOMATION SYSTEMS

(75) Inventors: Nagarajan Sethuraman, Bangalore (IN); Jerome O. Schroeder, Romeo, MI (US); Soumen De, Bangalore (IN); Chengyin Yuan, Rochester Hills, MI (US); Stephan R. Biller, Birmingham, MI (US); Frank Gajor, Livonia, MI (US); Jeffrey J. Byrnes, Lake Orion, MI (US); Narahari K. Hunsur, Bangalore (IN)

(73) Assignee: GM GLOBAL TECHNOLOGY OPERATIONS, INC., Detroit, MI (US)

(21) Appl. No.: 12/604,449

(22) Filed: Oct. 23, 2009

(51) Int. Cl. G06F 19/00; G06F 11/36; G05B 9/02

(52) U.S. Cl. 700/97; 714/26; 700/79; 714/E11.207

(57) ABSTRACT

A method and system is provided for verifying and certifying the safety logic of a manufacturing automation system including safety logic, where the logic may include one or more safety modules, routines, programs and tasks or a combination thereof; testing specifications corresponding to the safety logic; one or more formal model generators adapted for automatically transforming the safety logic and testing specifications through a logic parser into their respective mathematical models, formatted for example, as a Petri-net or binary decision diagram; a safety logic verifier configured for automatically comparing the safety logic formal model against the testing specification formal model to verify the safety logic model for the purpose of certifying the safety logic. The testing specifications may include testing of safety logic behavior including reaching safe state, remaining in safe state without reset, recovering from safe state with reset and remaining active with false alarm detection.

### TECHNICAL FIELD

The invention relates generally to the testing of automation logic, and in particular to a computer executable method and system for formal verification of the safety-related automation logic that is used in a manufacturing cell.

### BACKGROUND OF THE INVENTION

Automation logic, including safety-related logic that is used in a manufacturing cell, must be verified prior to implementation and deployment on the plant floor. A typical verification process requires setting up a hardware-based test-bed, which may be a prototype of the manufacturing cell and its safety control system. The physical safety components, for example, emergency stops, light curtains, gate and guard locks, safety mats and anti-tie down switches in the test-bed are connected to a safety automation controller or safety PLC through a safety network, which may be a separate network or integrated with the regular automation network. The automation logic to control the behavior of the physical safety components is provided through a safety enabled automation controller, for example, a safety programmable logic controller (PLC), and is referred to generally as safety-related logic or safety logic.

Informal testing specifications are developed based on high level safety functional requirements for the verification of safety logic. The term “informal” refers to specifications that are typically in native language, e.g., easy to understand written descriptions and refer to everything that is not based on a strictly composed, syntactically and semantically well-defined form. Informal testing specifications may include, for example, written descriptions of safety behavior requirements, timing diagrams, schematics, piping and instrumentation diagrams (P&ID) and hardware descriptions. The implemented control logic program is tested and validated against these informal specifications. The informal testing specifications are developed primarily to verify the basic “fail to safe” behavior of the safety logic, that is, to confirm the automation will respond to a safety concern signal by transitioning the manufacturing cell to a “safe state” by powering down, ceasing or slowing down operation of the cell and/or locking out equipment.

In a hardware-based verification process, the manufacturing and safety automation system hardware and controller, e.g., programmable logic controller (PLC) are connected and the physical safety components are manually, e.g., by a testing engineer, manipulated according to the informal testing specifications to generate the corresponding testing signals required for the various operating conditions for which the safety logic must be verified. As the PLC program, that is, the safety logic executes, the results are manually recorded, typically by screen printing the results from a monitor connected to the controller. The results are compared against the testing specifications, any inconsistencies are recorded and each testing scenario and related specifications are evaluated for pass/fail. A final report is created to establish the verification status of the safety logic to the testing specifications.

Setting-up and configuring the automation and safety hardware for testing, conducting the testing and recording and reporting the verification testing results is manually intensive and can often be inconsistent because of ambiguities in the informal specifications and variation in interpretation by the test engineer. Typically, the entire state space of the safety logic is not fully evaluated or verified, due to resource, timing and cost limitations as well as physical constraints of the hardware-based testing which prevent evaluation of the entire state space conditions, transitions and behaviors. Logic testing dependent upon physical inputs and manual triggers may not be repeatable and may be limited in ability to test timing response, simultaneous events, negative specification conditions and low probability combinations. Hardware-based verification testing may also be limited based on the availability of physical hardware, and may be further constrained if the hardware is prototype equipment or if simulated inputs are used where no equipment is available. Repeat testing may be required at production deployment, to verify changes and revisions, which may cause increased costs and potential delay in production implementation if safety logic corrective actions and further reverification is required.

### SUMMARY OF THE INVENTION

The use of formal methods for the verification of safety logic can result in reduced development time, decreased verification costs, improved verification confidence and expanded verification over the entire state space of the logic system. Provided herein is a system and method for formal verification of safety control logic in manufacturing automation systems which includes generating a formal mathematical model representing the safety logic to be verified and a formal mathematical model of the corresponding verification testing specifications, and comparing the formal or mathematical model of the safety logic against the formal or mathematical model of the testing specifications to verify and certify the behavior of the safety logic. This formal safety logic method and system of verification can be used to overcome limitations of traditional hardware-based verification systems, including expanding the verification criteria beyond the typical “fail to safe” evaluation, providing for the certification of safety modules including supplier provided (black box) modules and creating a library or database of certified logic and modules with corresponding testing specifications. The library can be used and reused to increase the efficiency and repeatability of safety logic development and verification testing and for control logic changes including reverification after modification of the automation safety system or logic. System behaviors in addition to “fail to safe” and conditions such as low probability events which are not typically verified in a physical test-bed scenario can be tested and verified using formal methods, and may include, for example, stay safe state without reset behavior, return to active state after reset transition, stay active state or false alarm negation, and response time requirements.

Additionally, use of formal safety logic verification streamlines the automation design and deployment, by providing the automation builder with certified logic and a set of corresponding testing specifications which must be used by the automation builder to verify and certify the automation system, including hardware and software with safety logic. The certified safety logic provided to the automation builder may include certified safety routines, programs and tasks. Verification testing specifications corresponding to the certified safety logic are also provided to the automation builder, and may include specification of certified safety modules for incorporation into the manufacturing automation.

The system and method of formal verification of safety logic provides a streamlined reporting system to produce safety logic certification reports. Manual input to the formal verification and reporting process is minimized, and the certification report is consistently structured, which is useful for providing certification reports to automation builders or for other certification requirements, including demonstrating compliance with government and regulatory safety and equipment automation standards and requirements.

The system for formal verification and certification of safety logic includes the safety logic which is to be verified, and a set of verification testing specifications corresponding to the safety logic to be verified. The safety logic and verification testing specifications are each developed based on high level safety requirements which may include, for example, functional requirements, schematics, timing diagrams and hardware descriptions.

The system includes a first formal model generator to transform the safety logic into a formal safety logic model. The safety logic formal model may be automatically generated, e.g., by a logic parser or similar method, into a mathematical model which may be in the form of a Petri-net, finite state machine, binary decision diagram (BDD), finite automata, extended finite automata, timed finite automata or other mathematical model typically used for this purpose.

The system further includes a second formal model generator to transform the verification testing specifications into a formal specification model. The testing specifications formal model may be automatically generated, by a logic parser or similar method, into a mathematical model which may be in the form of a Petri-net, finite state machine, binary decision diagram (BDD), finite automata, extended finite automata, timed finite automata or other mathematical model typically used for this purpose.

The first and second formal model generators may be of the same or different types. The safety logic model and the testing specification model may be of the same form or of different forms of mathematical models. For example, both models may be Petri-nets, or the logic model may be a Petri-net and the specification model may be a binary decision diagram. In either event, the formal verification method is effective.

A safety logic verifier is provided and is configured to compare the formal safety logic model against the formal testing specification model to determine verification of the safety logic model against the testing specification model for inconsistencies and to verify the behavior of the safety logic against the verification testing specification. The safety logic verifier may perform the comparison automatically. The system provides a corrective action process for resolving inconsistencies identified by the safety logic verifier during the comparison of the safety logic model against the testing specification model. The safety logic is certified when verification of the safety logic model against the testing specification model is completed without corrective action being required.

The system includes a report generator to generate a certification report upon completion of verification of the safety logic model. The certification report may be partially or fully produced automatically.

The safety logic to be verified may be one of a safety module, a safety routine, a safety program, a safety task, or a combination thereof, including a combination which is the system of safety logic in its entirety. A safety routine may contain a single safety module, where verification of the routine provides certification of the module, which may be a black box module, e.g., supplier provided, and certification of the routine including the module. A black box module is defined as a module where the module logic is inaccessible or cannot be changed within the verification system or method. Typically, for a user, the behavior of a black box safety module is defined and understood based on a supplier provided manual or documents. A safety program may include one or more safety routines executed in a specified order, and a safety task may include at least one safety program.

The formal safety verification and certification system may include a library, database or collection of certified safety logic, providing, for example, one or more certified safety modules, certified safety routines, certified safety programs, and certified safety tasks, or a combination thereof. The system may further include a library, database or collection of verification testing specifications corresponding to the certified safety logic. Certified safety logic, including certified safety modules, from the logic library may be selected and used in the development of safety logic including safety routines, programs, tasks or systems. Verification testing specifications from the specification library may be selected and used to develop testing specification models corresponding to certified safety logic or for reverification testing. The safety logic verifier may be configured to recognize certified safety logic and corresponding testing specifications and may be configured further to bypass comparison of the certified logic model against its corresponding testing specification model, thus resulting in efficiencies in verification testing.

In particular, a method for verifying and certifying the safety logic of a manufacturing automation system by formal verification includes selecting safety logic to be verified and generating a formal model of the safety logic; selecting a testing specification corresponding to the safety logic to be verified and generating a formal model of the testing specification; then verifying the formal model of the safety logic against the formal model of the testing specification, using a safety logic verifier module, by comparing the logic model against the specification model to certify the safety logic.

In a preferred embodiment, the safety logic formal model may be automatically generated as a mathematical model through a logic parser in the form of a petri-net, finite state machine, binary decision diagram or other mathematical model typically used for this purpose. The testing specification formal model may be automatically generated as a mathematical model through a logic parser in the form of a petri-net, finite state machine, binary decision diagram or other mathematical model typically used for this purpose.

The safety logic may be verified against an “active to safe” testing scenario, to verify “fail to safe” behavior and performance responsive to the activation of a safety device or condition, e.g., the triggering of safety inputs. The safety logic may be further verified against a “stay safe” testing scenario to verify the safety system remains in the safe state unless all fault resets are activated and safety inputs are returned to normal after a “fail to safe” transition has occurred. The safety logic may also be verified against a “safe to active” testing scenario to verify the system returns from a safe state to an active or ready state when all fault resets are activated and safety inputs return to normal following a “fail to safe” event. The safety logic may finally be verified against a “stay active” testing scenario to verify the system stays in an active or ready state in a negative specification condition or under other conditions which represent a false alarm to the safety system.

As will be understood by those of ordinary skill in the art, the formal system and method for verification and certification of safety logic as described herein can also be used for the verification and certification of non-safety logic, which includes but is not limited to normal logic of the type used in programmable controllers known as PLCs. The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a flow chart describing a system for formal verification of safety logic;

FIG. 2 is a flow chart describing the system of FIG. 1 adapted for formal verification of a safety module; and

FIG. 3 is a flow chart describing a method for formal verification of safety logic.

### DESCRIPTION OF THE PREFERRED EMBODIMENTS

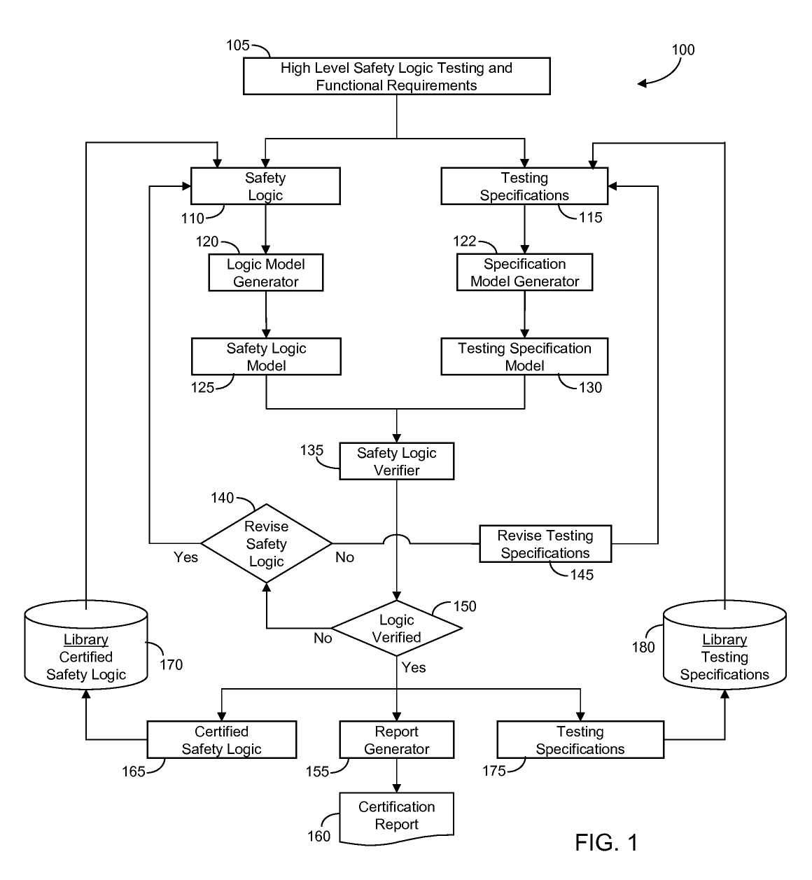

Referring to the drawings, and beginning with FIG. 1, generally indicated at 100 is a preferred embodiment of a system for the formal verification and certification of safety logic 110. Safety logic 110 is of the type typically used for control logic of safety-related systems in manufacturing cells, for example, in the logic of programmable logic controllers (PLC). The safety logic 110 may be stored in or provided through a controller, e.g., programmable logic controller (PLC) or accessible thereby, including the safety logic 110 as described below with reference to FIGS. 1-3. Safety logic 110 can be stored in ROM and automatically executed by a controller to provide the required functionality. The controller, e.g., PLC, may be configured as a digital computer having a microprocessor or central processing unit, read only memory (ROM), random access memory (RAM), electrically-erasable programmable read only memory (EEPROM), high speed clock, analog to digital (A/D) and digital to analog (D/A) circuitry, and input/output circuitry and devices (I/O), as well as appropriate signal conditioning and buffer circuitry. As will be understood by those of ordinary skill in the art, the formal verification and certification system 100 can also be used for verification and certification of other types of automation logic, including normal (non-safety) automation logic.

As shown in FIG. 1, high level safety logic testing requirements 105 are initially identified, which may also include functional specifications, and are typically provided in native language. High level safety logic testing requirements 105 may also be referred to herein as high level requirements 105. Safety logic 110 is developed based on high level requirements 105. Testing specifications 115 are developed based on high level requirements 105. Testing specifications 115 are developed as verification specifications, that is, testing specifications 115 are used to determine and verify whether the behavior of safety logic 110 meets high level requirements 105.

Safety logic 110 may include one or more safety modules, safety routines, safety programs and safety tasks. As used herein, the term “safety logic” may generally refer to a system of safety logic, or to an element or subset of the safety logic system, for example, any of one or more of a safety module, safety routine, safety program and safety task, or combination thereof “Safety logic” may also refer to the entire system of safety logic used to control a manufacturing cell. As another example, “safety logic” may refer to the safety logic module or block used to control an emergency stop (ESTOP), a safety light curtain or other single safety device for a single piece of equipment within a manufacturing cell.

The verification system 100 shown in FIG. 1 operates by comparison of a safety logic model 125 which is a mathematical or formal model of safety logic 110 against a testing specification model 130 which is a mathematical or formal model of testing specifications 115 corresponding to safety logic 110. The mathematical models, which are also known as formal models, are automatically generated by logic and specification testing model generators 120, 122, respectively, which each may be a logic parser or other means of generating a mathematical model known by those skilled in the art. The mathematical model generated may be in the form of a Petri-net, finite state machine or binary decision diagram or similar format.

Referring to FIG. 1, the safety logic 110 to be verified is selected by a testing engineer, e.g., from a controller, or is selected from a logic testing sequence which may be automatic or pre-programmed. The safety logic 110 to be verified may include some elements of certified safety logic from logic library or database 170. The certified safety logic elements included from logic library 170 may be any of one or more of a safety module, safety routine, safety program or safety task, or combination thereof. Safety logic 110 which is to be verified is automatically converted into a formal or mathematical safety logic model 125, which may be, for example, a Petri-net, by a logic model generator 120. The certified elements from logic library 170 included in safety logic 110 are converted by logic model generator 120 and included in safety logic model 125.

Testing specifications 115 which correspond to the safety logic 110 to be verified are selected. The testing specifications 115 may consist of one or more testing specifications, and may include testing specifications from specification library or database 180 which correspond with certified logic from logic library 170 included in safety logic 110. Testing specifications 115 corresponding to safety logic 110 are automatically converted by a logic parser or similar means into a formal or mathematical testing specification model 130 which may be, for example, a binary decision diagram, by a specification model generator 122.

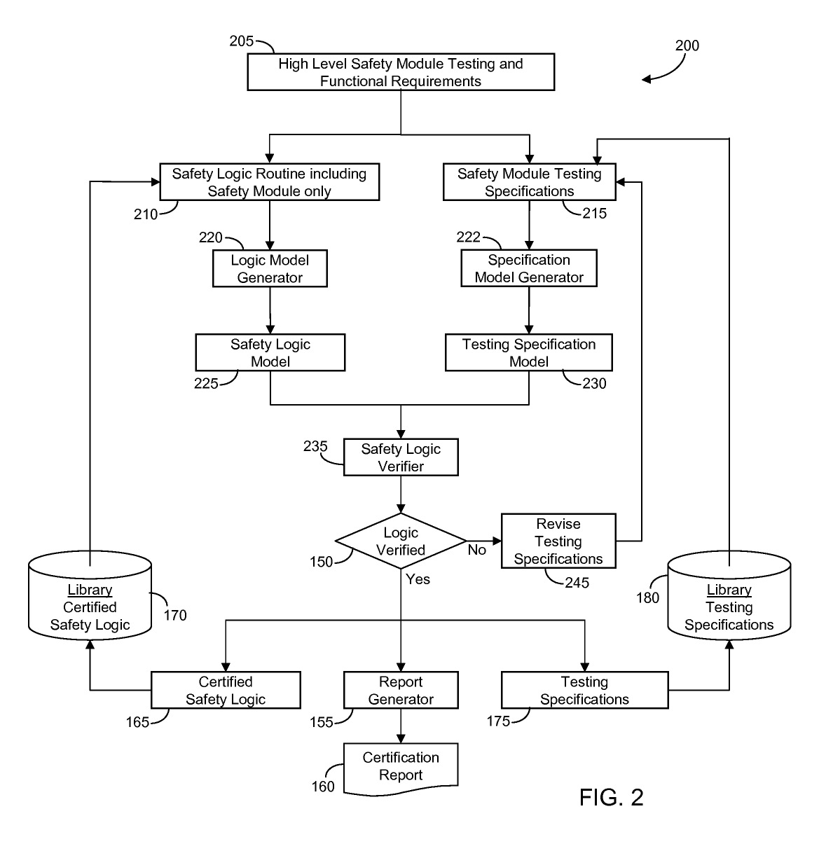

Included in the system 100 shown in FIG. 1 is a safety logic verifier 135 which automatically compares safety logic model 125 to testing specification model 130, using the verification method shown in additional detail in FIG. 2. If the comparison of safety logic model 125 to testing specification model 130 is successful, that is, if no inconsistencies are determined between the two logic models 125 and 130, then safety logic 110 is determined to be verified (shown at 150) against testing specification 115, and the report generator 155 produces a certification report 160. Certified safety logic 165 is added to a logic library 170. Certified safety logic 165 may be included in or as an element of safety logic 110 subsequently selected for verification. The testing specifications 175 corresponding to the certified safety logic 165 are added to a testing specifications library 180. Testing specifications 175 may be included in testing specifications 115 in subsequent verification processes, where testing specifications 175 correspond to certified safety logic 165 included in safety logic 110 to be verified.

The safety logic verifier 135 may be configured to recognize elements of certified safety logic 165 included in safety logic 110, and may be further configured to recognize testing specifications 175 within the testing specifications 115 which correspond to the included certified logic 165. The safety logic verifier 135 can be configured to bypass comparison of the certified elements of the safety logic 165 with corresponding testing specifications 175 during the comparison process, thus gaining efficiencies in the verification process.

Referring again to FIG. 1, if the comparison performed by the safety logic verifier 135 is unsuccessful, that is, if inconsistencies are determined between the logic model 125 and the specification model 130, then it is determined at 150 that the safety logic 110 has not been verified and corrective action is required to resolve the inconsistencies. Corrective action is selected from one of revising the safety logic 110 (shown at 140) or revising the testing specification 115 (shown at 145). The method of corrective action selected must be appropriate to resolve the identified inconsistency and may be selected by a person skilled in the art, e.g., a testing engineer or control engineer, or may be selected automatically by a corrective action system or method configured to do so. More than one corrective action may be required to resolve the inconsistencies identified by the safety logic verifier 135 and may include revision of the safety logic and the testing specification, followed by reverification described as follows. For each verification step which is unsuccessful, the software logic verifier may prompt the report generator to produce a verification report to record the inconsistencies which have been determined and the associated corrective actions taken.

As shown in FIG. 1, if the corrective action selected is revision of the safety logic, then safety logic 110 is revised to resolve the inconsistency. Following revision of the safety logic 110, the verification process 100 is repeated, beginning with the conversion of revised safety logic 140 by logic model generator 120 and conversion of testing specifications 115 by specification model generator 122 into their respective formal models for comparison by safety logic verifier 135 and further corrective action if needed, until the comparison is successful and the safety logic and testing specifications become certified.

Not shown in FIG. 1, but understood by those skilled in the art, if the corrective action selected is the revision of testing specification 115, then the revised testing specification 145 must be validated against the high level safety logic testing requirements and functional specifications 105 prior to being used for verification testing in system 100. Following revalidation of revised testing specification 145, the verification process 100 is repeated, beginning with the conversion of safety logic 110 by logic model generator 120 and the conversion of revised testing specifications 145 by model generator 122 into their respective formal models for comparison by safety logic verifier 135 and further corrective action if needed, until the comparison is successful and the safety logic becomes certified.

The system 100 of FIG. 1 may also be adapted for the certification of a safety module, for example, an emergency stop (EStop) provided by a third party, where the module is a black box, e.g., the safety logic of the module is either not accessible or cannot be modified within the verification system. Shown in FIG. 2 is a flow chart describing a system 200 adapted from the system 200, for formal verification of a safety module. To certify the safety module, which may also be referred to as a safety block or construct, a safety logic routine is created including a single safety module only. The single safety routine including a single safety module becomes the safety logic 210 selected for verification using system 200. A testing specification 215 representing the safety functional specifications 205 of the safety logic module is created, and then converted to a testing specification model 230 through a specification model generator 222. Safety logic 210 is converted by logic model generator 220 into a safety logic model 225 and the logic model 225 is compared to specification model 230 by the safety logic verifier 235. If there are inconsistencies identified, that is, if the verification is not successful, then corrective action is required. Because the logic of the third party (black box) safety module cannot be modified, the testing specification is revised and the revised testing specification 245 is converted to a specification model 230 for comparison against safety module model 225. When verification is successful, the method proceeds as described previously, and the safety module is certified and added to the certified library 170. An advantage of certifying a safety module is to assist the user to better understand the behavior of each safety module for proper application within the safety logic. Other advantages of certifying a safety module include predictable and verified behavior of the module without reverification and certification of functionality and behavior prior to incorporating the safety module into a safety system.

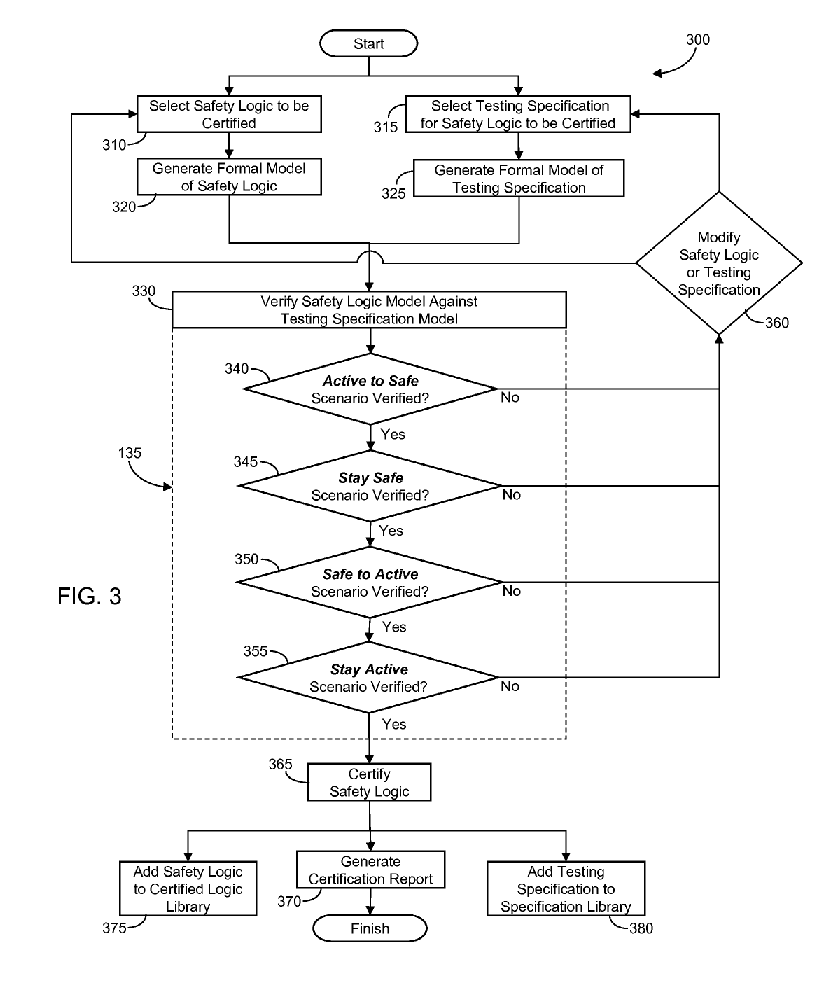

Referring to FIG. 3, generally indicated at 300 is a method for verification and certification of safety logic 110, 210 using the system 100, 200 described previously and shown in FIGS. 1 and 2, respectively. Method 300 illustrates additional details of the verification process performed by the safety logic verifier 135. As described for use with the structure shown in FIGS. 1 and 2, method 300 begins with step 310, the selection of the safety logic to be verified and step 315, the selection of the testing specifications corresponding to the safety logic selected for verification. As described previously, the selection of safety logic to be verified may include selecting certified safety logic from a library. Similarly, the selection of testing specifications may include selecting testing specifications from a library. Testing scenarios will also be included for the verification of four transition conditions, referred to herein as “active to safe,” “stay safe,” “safe to active,” and “stay active.”

Formal models of the selected safety logic and selected testing specifications are generated at steps 320 and 325, respectively, and are provided for comparison by the safety logic verifier 135 consecutively through steps 330, 340, 345, 350 and 355, which will be further described in detail. Upon successful completion of the verification process, the safety logic is certified at step 365, and a certification report is generated at step 370. The certified safety logic is added to the certified logic library at step 375 and the corresponding testing specification is added to the specification library at step 380.

FIG. 3 shows the verification steps performed by logic verifier 135 in additional detail. For each consecutive verification step 330, 340, 345, 350 and 355, the formal model of the safety logic generated in step 320 is compared with the portion of the formal testing specification model generated in step 325. Upon successful completion of each verification step, the verifier 135 proceeds to the next consecutive verification step. For example, upon successful completion of step 330, the verifier 135 proceeds to step 340, and so on, until the steps 330, 340, 345, 350 and 355 are consecutively successfully completed without need for corrective action and the verification method proceeds to certify the safety logic at step 365.

If the comparison performed by the safety logic verifier 135 is unsuccessful during any single step of the verification method, then the safety logic is determined to be not verified and corrective action is required. For example, if the safety logic verifier 135 has successfully verified the safety logic model through step 345, then is unsuccessful in verifying step 350, the method proceeds to step 360 for corrective action. The verifier 135 ceases comparison of the unverified logic and specification models. After corrective action step 360 is completed as described previously for FIGS. 1 and 2, the verification method is reinitiated at steps 310 and 315 with the revised safety logic and/or testing specification. Formal models are generated from the revised safety logic and/or testing specification and are sent to the logic verifier 135 to initiate verification at step 330, and so on, until the steps 330, 340, 345, 350 and 355 are consecutively successfully completed without need for corrective action and the verification method proceeds to certify the safety logic and testing specification at step 365.

Still referring to FIG. 3, each verification step executed by the logic verifier 135 will be detailed. In step 330, the safety logic model is compared against the testing specification model for all required attributes not verified in steps 340, 345, 350 and 355. These attributes may include, for example, general functional characteristics of the safety logic being verified.

In step 340, the safety logic model is compared against an “active to safe” testing scenario model. The “active to safe” condition, also referred to as an “active to safe” transition, which is being verified in step 340 could also be referred to as an “active to fail,” “ready to safe,” or “ready to fail” transition or condition. The “active to safe” transition is the transition which occurs when a safety device or safety condition is activated in the system, and as a consequence, the related safety logic output(s) is energized so as to place the system in a safe state. For example, when an emergency stop button is pushed by the operator of a manufacturing cell, the emergency stop (EStop), which is a safety device, is activated, and as a consequence, the safety logic output(s) are energized so as to place the equipment in the manufacturing cell in a safe state, typically by ceasing operation of the equipment and powering off all motion, e.g. stopping robots, conveyors, etc. Accordingly, the manufacturing cell is transitioned from an “active” state to a “safe” state in response to the activation of the EStop safety device. Another example of activation of a safety device is breaking the light beam of a light curtain, where safety logic would respond to the signal the light curtain has been broken by sending the system to a safe state. Similarly, the “active to safe” transition should occur in response to activation of a safety condition, for example a sensor triggered by the opening of a guard or gate permitting an operator to cross a perimeter fence and access the manufacturing cell during operation, or a signal that an anti-tie down device has failed to cycle or has been disabled. In step 340, the “active to safe” testing specification model is compared with the safety logic model to verify the safety system will always fail to safe, e.g., transition from “active to safe” upon activation of a safety device or condition.

In step 345, the safety logic model is compared against a “stay safe” testing scenario model. The “stay safe” condition which is being verified in step 345 could also be referred to as a “stay in fail state” or “stay in safe state” condition. The “stay safe” condition is the condition which occurs when the input channels of a safety device or safety condition start behaving in a normal way prior to achieving a fault reset condition. In this condition, the system must “stay safe,” e.g., the system must not reactivate, even though all safety device and safety condition input channels are in a normal (de-activated) condition so long as a fault reset condition is de-activated, e.g., the fault reset has not occurred. For example, when the system has been powered down into a safe state in reaction to a break in the light beam of a safety light curtain, the system must “stay safe” even if the light beam is no longer being broken, until the fault reset is activated, for example, by pressing a fault reset button on the manufacturing cell control panel. In step 345, the “stay safe” testing specification model is compared with the safety logic model to verify the safety system will always remain in a safe state until both conditions are satisfied, e.g., the safety device or condition is cleared (returns to normal) and the fault reset is activated.

In step 350, the safety logic model is compared against a “safe to active” testing scenario model. The “safe to active” condition, also referred to as a transition, which is being verified in step 350 could also be referred to as a “safe to ready,” or “fail to ready” transition or condition. The “safe to active” condition is the condition which occurs when the input channels of all safety devices and safety conditions start behaving in a normal way and a fault reset condition is achieved. In this condition, the system transitions from “failed to active,” e.g., the system is reactivated by powering up and becoming functional. For example, when the system has been powered down into a safe state in reaction to a break in the light beam of a safety light curtain, the system will transition from “safe to active” when two conditions are satisfied. First, the light beam must no longer be broken, e.g., the safety device deactivates; and secondly, the fault reset is activated, for example, by pressing a fault reset button on the manufacturing cell control panel corresponding to the light curtain. Upon satisfaction of these two conditions, the system will reactivate by powering up the equipment, removing lock-outs, energizing conveyors, etc. In step 350, the “safe to active” testing specification model is compared with the safety logic model to verify the system will activate to a ready or operational state when both conditions are satisfied, e.g., the safety device or condition is de-activated (returns to normal) and the fault reset is activated.

In step 355, the safety logic model is compared against a “stay active” testing scenario model. The “stay active” condition, which is being verified in step 355 could also be referred to as a “stay in ready state” or “stay in active state” condition. The “stay safe” condition is the condition which occurs when the system input channels of a safety device or safety condition are behaving in a normal way. To prevent unnecessary stoppages and manufacturing downtime due to “fail to function” conditions caused by “false alarms,” the safety logic may also identify “negative spec” conditions. A “negative spec” flag indicates a specified end condition that should never happen. For example, in a manufacturing cell with only one robot with an EStop button, when both input channels of a robot's EStop module are normal, then the cell should not sense the EStop output is energized, and is prevented from doing so with a negative specification (NEG_SPEC) flag. In this condition, the system should “stay active,” e.g., the system should not power down. In step 355, the “stay active” testing specification model is compared with the safety logic model to verify the system will remain in an active state when the all safety devices or conditions are de-activated (normal) and when negative spec conditions are encountered, e.g., the system will remain active when a “false alarm” is detected.

While the best modes for carrying out the invention have been described in detail, those familiar with the art to which this invention relates will recognize various alternative designs and embodiments for practicing the invention within the scope of the appended claims.

1. A method for certifying the safety logic of a manufacturing automation system by formal verification, the method comprising:
selecting safety logic to be verified;
generating a formal model of the safety logic using a logic model generator;
selecting a testing specification corresponding to the safety logic to be verified;
generating a formal model of the testing specification using a specification model generator;
verifying the formal model of the safety logic against the formal model of the testing specification using a safety logic verifier; and
certifying the safety logic using a safety logic verifier.

2. The method of claim 1,
the logic model generator including a logic parser;
wherein generating the formal model of the safety logic includes automatically generating a mathematical model using the logic parser; and
the specification model generator including a logic parser;
wherein generating the formal model of the testing specification includes automatically generating a mathematical model using the logic parser.

3. The method of claim 2,
wherein the mathematical model of each of the safety logic and the testing specification is in the form of one of a Petri-net, a finite state machine, a finite automata, an extended finite automata, a timed finite automata, and a binary decision diagram.

4. The method of claim 1,
wherein the safety logic includes a single safety routine; and
wherein certifying the safety logic further comprises:
certifying the safety routine using a safety logic verifier.

5. The method of claim 4,
wherein the single safety routine includes a single safety module; and
wherein certifying the safety logic further comprises:
certifying the safety module using a safety logic verifier.

6. The method of claim 1,
wherein the safety logic includes a safety program comprising at least two safety routines executed in a specified order; and
wherein certifying the safety logic further comprises:
certifying the safety program using a safety logic verifier.

7. The method of claim 1,
wherein the safety logic includes a safety task comprising at least one safety program, wherein the at least one safety program comprises at least two safety routines executed in a specified order; and
wherein certifying the safety logic further comprises:
certifying the safety task using a safety logic verifier.

8. The method of claim 1, wherein verifying the formal model of the safety logic against the formal model of the testing specification further comprises verifying the safety logic against an active to safe testing scenario using a safety logic verifier.

9. The method of claim 8, further comprising at least one of:
verifying the safety logic against a stay safe testing scenario;
verifying the safety logic against a safe to active testing scenario; and
verifying the safety logic against a stay active testing scenario;
using a safety logic verifier.

10. The method of claim 1, further comprising:
adding the certified safety logic to a certified safety logic library; and
adding the corresponding testing specification to a library of testing specifications.

11. The method of claim 1, wherein selecting safety logic to be verified includes selecting certified safety logic which comprises at least one of a certified safety module, a certified safety routine and a certified safety program.

12. The method of claim 11, wherein selecting the testing specification includes selecting a testing specification which corresponds to the selected certified safety logic.

13. The method of claim 1, further comprising generating a certification report using a report generator.

14. A system for verifying and certifying the safety logic of a manufacturing automation system, the system comprising:
a system of safety logic;
a set of testing specifications, wherein each of the testing specifications corresponds to at least a portion of the system of safety logic;
a first formal model generator adapted for automatically transforming the portion of safety logic to be verified into a formal safety logic model;
a second formal model generator adapted for automatically transforming the testing specifications corresponding to the portion of safety logic to be verified into a formal testing specification model; and
a safety logic verifier configured for automatically comparing the safety logic model against the testing specification model to determine verification of the safety logic model against the testing specification model;
wherein the portion of safety logic is certified upon verification of the safety logic model against the testing specification model.

15. The system of claim 14, further comprising:
a report generator;
wherein the report generator is adapted to automatically generate a certification report upon verification of the safety logic model against the testing specification model.

16. The system of claim 14, wherein the portion of safety logic to be verified may be one of a safety module, a safety routine, a safety program, a safety task, or a combination thereof, including a combination which is the system of safety logic in its entirety;
wherein a safety task includes at least one safety program; and
wherein the at least one safety program comprises at least two safety routines executed in a specified order.

17. The system of claim 16, further comprising:
a library of certified safety logic;
wherein the library provides at least one of a certified safety module, a certified safety routine, a certified safety program, a certified safety task, or a combination thereof, including a combination which is the certified system of safety logic; and
a library of testing specifications corresponding to the certified safety logic.

18. The system of claim 17:
wherein the safety logic is developed at least partially using certified safety logic;
wherein the testing specifications are developed at least partially using the testing specifications corresponding to the certified safety logic; and
wherein the safety logic verifier is configured to automatically verify the certified safety logic.

19. The system of claim 14, wherein the testing specifications corresponding to the safety logic to be verified include an active to safe testing scenario; and
wherein the safety logic verifier compares the safety logic model to an active to safe testing scenario model to determine verification of the safety logic model against the testing specification model.

20. The system of claim 19, wherein the testing specifications corresponding to the safety logic to be verified include:
at least one of a stay safe testing scenario, a safe to active testing scenario, and a stay active testing scenario; and
wherein the safety logic verifier compares the safety logic model to the at least one of a stay safe testing scenario model, a safe to active testing scenario model, and a stay active testing scenario model to determine verification of the safety logic model against the testing specification model.
